(19) United States
(12) Patent Application Publication
(10) Pub. No.: US 2024/0242325 A1
(43) Pub. Date: Jul. 18, 2024

(54) INSPECTION SUPPORT DEVICE, INSPECTION SUPPORT SYSTEM, INSPECTION SUPPORT METHOD, AND STORAGE MEDIUM

(71) Applicant: Mitsubishi Electric Corporation, Chiyoda-ku, Tokyo (JP)

(72) Inventor: Harunori KOIKE, Tokyo (JP)

(73) Assignee: Mitsubishi Electric Corporation, Chiyoda-ku, Tokyo (JP)

(21) Appl. No.: 18/559,225

(22) PCT Filed: Jun. 8, 2021
(86) PCT No.: PCT/JP2021/021790

§ 371 Date: Nov. 6, 2023

(51) Int. Cl. G06T 7/00; G06V 10/764; G06V 10/776; G06V 20/50; H04N 7/18

(52) U.S. Cl. CPC G06T 7/0002; G06V 10/764; G06V 10/776; G06V 20/50; G06T 2207/20081; G06T 2207/20084; H04N 7/183

(57) ABSTRACT

An inspection support device includes: a transmission/reception unit acquiring image data captured by a camera installed on an inspection robot capable of traveling inside a generator; a classification unit using a classification model, which is a trained model for determining class indicating degree of anomaly from the image data, and the image data to determine the class corresponding to the image data; an object detection unit using an object detection model, which is a trained model for identifying foreign substance in the generator from image data, and the image data to determine which object is the foreign substance in an image; a result integration unit using results of determination by the classification unit and the object detection unit to select, from the image data, image data to be checked; and a result presentation unit presenting the image data to be checked and the results of determination to the inspection worker.

### FIELD

The present disclosure relates to an inspection support device that supports an inspection of a generator, an inspection support system, an inspection support method, and a storage medium.

### BACKGROUND

A generator is subject to periodic inspections, but when, for example, a rotor is pulled out in order to perform a precise inspection, the generator is stopped for a long period of time for the inspection. Therefore, in recent years, the inspection has been performed using an inspection robot that travels in a gap such as between a stator and the rotor of the generator. Patent Literature 1 discloses an inspection robot for generator inspection that travels while equipped with a sensor such as a camera. When the inspection robot for generator inspection described in Patent Literature 1 is used, an inspection worker checks a camera image and a sensor value acquired by the inspection robot for generator inspection, whereby the generator can be inspected without requiring pulling out of the rotor or the like.

### CITATION LIST

### Patent Literature

Patent Literature 1: Japanese Patent Application Laid-open No. 2018-118733

### SUMMARY OF INVENTION

### Problem to be Solved by the Invention

Meanwhile, when performing the inspection using the inspection robot for generator inspection, the inspection worker visually checks images obtained as a moving image by the travel of the inspection robot for generator inspection. Even in the case where the inspection robot for generator inspection is used, the inspection of the generator places a load on the inspection worker over several days. Therefore, it is desired to reduce the workload of the inspection worker.

The present disclosure has been made in view of the above, and an object of the present disclosure is to provide an inspection support device capable of reducing a workload of an inspection worker in inspecting a generator.

### Means to Solve the Problem

In order to solve the above-described problems and achieve the object, an inspection support device according to the present disclosure includes: an acquisition unit to acquire image data that is data of an image captured by a camera installed on an inspection robot capable of traveling inside a generator, and a classification unit to use a classification model, which is a trained model for determining a class indicating a degree of anomaly of the generator from the image data, and the image data acquired by the acquisition unit to determine the class corresponding to the image data acquired by the acquisition unit. The inspection support device further includes: an object detection unit to use an object detection model, which is a trained model for identifying a foreign substance in the generator from image data, and the image data acquired by the acquisition unit to determine which object is the foreign substance in an image corresponding to the image data acquired by the acquisition unit; a result integration unit to use a result of determination by the classification unit and a result of determination by the object detection unit to select, from the image data acquired by the acquisition unit, image data to be checked that is the image data to be presented to an inspection worker, and a result presentation unit to present the image data to be checked, the result of determination by the classification unit, and the result of determination by the object detection unit to the inspection worker.

### Effects of the Invention

The inspection support device according to the present disclosure has an effect of being able to reduce the workload of the inspection worker in inspecting the generator.

### BRIEF DESCRIPTION OF DRAWINGS

FIG. 1 is a diagram illustrating an example of a configuration of an inspection support system according to an embodiment.

FIG. 2 is a flowchart illustrating an example of processing that generates a trained model of the embodiment.

FIG. 3 is a diagram schematically illustrating an example of an image displayed by a display unit of the embodiment.

FIG. 4 is a diagram schematically illustrating another example of an image displayed by the display unit of the embodiment.

FIG. 5 is a schematic diagram illustrating an example of a neural network.

FIG. 6 is a flowchart illustrating an example of inspection support processing in the inspection support device of the embodiment.

FIG. 7 is a flowchart illustrating an example of relearning processing of the embodiment.

FIG. 8 is a diagram illustrating an example of relearning of the embodiment.

FIG. 9 is a diagram illustrating an example of a configuration of a computer system that implements the inspection support device of the embodiment.

### DESCRIPTION OF EMBODIMENT

Hereinafter, an inspection support device, an inspection support system, an inspection support method, and a storage medium according to embodiments will be described in detail with reference to the drawings.

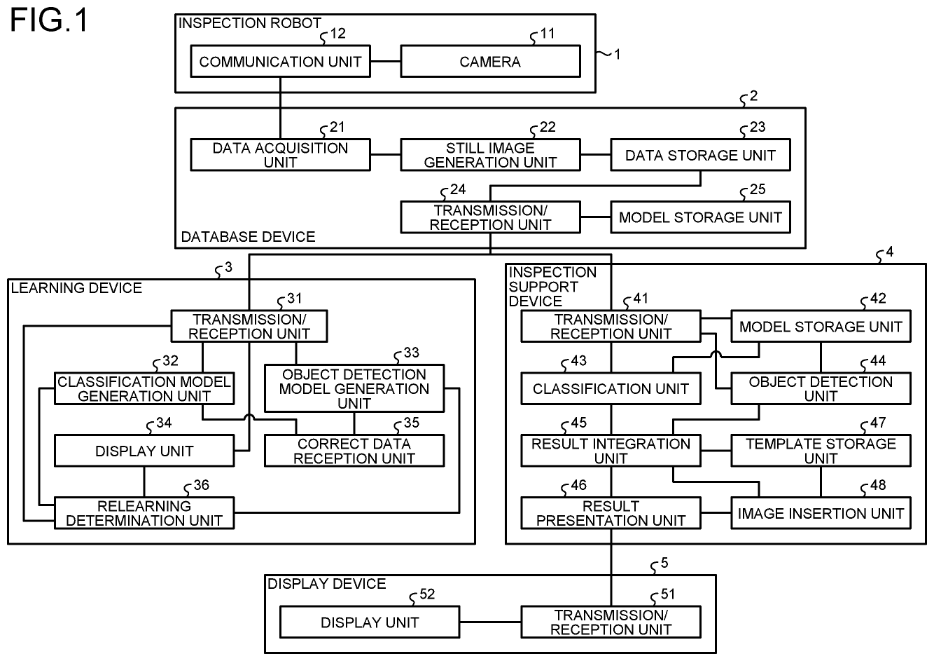

FIG. 1 is a diagram illustrating an example of a configuration of an inspection support system according to an embodiment. As illustrated in FIG. 1, the inspection support system of the present embodiment includes a database device 2, a learning device 3, an inspection support device 4, and a display device 5. The inspection support system may also include an inspection robot 1.

The inspection robot 1 is an inspection robot that can travel inside a generator for inspecting the generator, and includes a camera 11 and a communication unit 12. The inspection robot 1 may be equipped with a sensor (not illustrated) other than the camera 11. The inspection robot 1 includes a running gear such as a caterpillar running gear and captures images with the camera 11 while traveling to acquire video data of the interior of the generator. The communication unit 12 transmits the video data captured by the camera 11 to the database device 2. Note that the inspection robot 1 may be connected by wire to a recorder (not illustrated), in which case the video data may be accumulated in the recorder, and the database device 2 may acquire the video data from the recorder. The video data is a moving image captured at a set frame rate, and is a plurality of pieces of image data captured in each time period.

The database device 2 includes a data acquisition unit 21, a still image generation unit 22, a data storage unit 23, a transmission/reception unit 24, and a model storage unit 25. The data acquisition unit 21 acquires the video data from the camera 11, and outputs the acquired video data to the still image generation unit 22. The still image generation unit 22 divides the video data into still images, and stores pieces of image data as still image data in the data storage unit 23. Each of the image data obtained by the division is the data of the image captured by the camera 11. The data storage unit 23 stores the image data received from the still image generation unit 22 and also stores information such as an operation start date of the generator, design information indicating a color, a shape, and the like of the generator, a past inspection date, and a past inspection result as auxiliary information. The auxiliary information includes, for example, at least one of the operation start date of the generator, the design information of the generator, and the past inspection result of the generator. The auxiliary information may be received from another device via the transmission/reception unit 24, or may be input by input means (not illustrated) of the database device 2. The data acquisition unit 21 may also acquire image data obtained by inspecting a plurality of generators. In this case, the auxiliary information includes, for each of the generators, the information such as the operation start date of the generator, the design information indicating the color, the shape, and the like of the generator, the past inspection date, and the past inspection result.

The transmission/reception unit 24 transmits and receives information to and from another device such as the learning device 3 or the inspection support device 4. When receiving a trained model from the learning device 3, the transmission/reception unit 24 stores the received trained model in the model storage unit 25. As described later, in the present embodiment, the learning device 3 generates two types of the trained models, and thus the model storage unit 25 stores these two types of the trained models, the two types of the trained models being: the trained model for determining a class indicating a degree of anomaly of the generator, that is, a classification model as the trained model for classification; and the trained model for identifying a foreign substance in the generator from the image data, that is, an object detection model as the trained model for object detection. Moreover, the transmission/reception unit 24 transmits the classification model and the object detection model stored in the model storage unit 25 to the inspection support device 4. The database device 2 may transmit the classification model and the object detection model when the model is updated or when the inspection support device 4 gives an instruction for transmission. The model storage unit 25 stores the classification model and the object detection model.

The learning device 3 includes a transmission/reception unit 31, a classification model generation unit 32, an object detection model generation unit 33, a display unit 34, a correct data reception unit 35, and a relearning determination unit 36. The transmission/reception unit 31 transmits and receives information to and from another device such as the database device 2. The transmission/reception unit 31 acquires, from the database device 2, the image data and the auxiliary information stored in the data storage unit 23, and outputs the acquired image data and auxiliary information to the display unit 34. Also, when receiving the classification model from the classification model generation unit 32, the transmission/reception unit 31 transmits the classification model to the database device 2, and when receiving the object detection model from the object detection model generation unit 33, the transmission/reception unit 31 transmits the object detection model to the database device 2.

The display unit 34 displays an image based on the video data captured by the camera 11. Specifically, the display unit 34 displays the image data received from the transmission/reception unit 31 as an image and displays the auxiliary information corresponding to the image data. An expert who has knowledge about the generator checks the image and the auxiliary information displayed on the display unit 34 to determine the class indicating the degree of anomaly in the image and, when a foreign substance is present in the image, determine the name of an object as the foreign substance. Examples of the object as the foreign substance include a nail, a piece of plastic, a piece of epoxy, and the like, but is not limited thereto, and include an object previously detected as a foreign substance in the generator, an object possibly present as a foreign substance, and the like.

The correct data reception unit 35 receives an input of the result of determination of the class that is a piece of correct data for generating the classification model corresponding to the image data, and receives an input of the name of the object as the foreign substance that is a piece of correct data for generating the object detection model corresponding to the image data. Specifically, the correct data reception unit 35 receives, from an expert, the input of the result of determination of the class as the correct data to be used for generating the classification model, and outputs the received result of determination to the classification model generation unit 32. The correct data reception unit 35 also receives, from an expert, the input of the result of determination of the name of the object as the correct data to be used for generating the object detection model, and outputs the received result of determination to the object detection model generation unit 33.

The classification model generation unit 32 generates the classification model by using a plurality of learning data sets each including the image data and the result of determination of the class received by the correct data reception unit 35, Specifically, the classification model generation unit 32 uses a set of the image data and the correct data, which corresponds to the image data and is received from the correct data reception unit 35, as the learning data set, and uses a plurality of the learning data sets to perform machine learning and generate the classification model that is the trained model. The classification model generation unit 32 outputs the generated classification model to the transmission/reception unit 31.

The object detection model generation unit 33 generates the object detection model by using a plurality of learning data sets each including the image data and the name of the object received by the correct data reception unit 35. Specifically, the object detection model generation unit 33 uses a set of the image data and the correct data, which corresponds to the image data and is received from the correct data reception unit 35, as the learning data set, and uses a plurality of the learning data sets to perform machine learning and generate the object detection model that is the trained model. The object detection model generation unit 33 outputs the generated object detection model to the transmission/reception unit 31.

In a case where a result of determination obtained by inputting the image data to the classification model does not match a result of determination obtained by inputting the image data to the object detection model, the relearning determination unit 36 determines the image data to be a relearning candidate and causes the display unit 34 to display an image based on the relearning candidate. Specifically, the relearning determination unit 36 acquires, via the transmission/reception unit 31, a result of determination by the inspection support device 4 and corresponding image data from the database device 2, determines whether or not to perform relearning using the result of determination, and, when having determined to perform relearning, causes the object detection model generation unit 33 or the classification model generation unit 32 to perform relearning.

The inspection support device 4 includes a transmission/reception unit 41, a model storage unit 42, a classification unit 43, an object detection unit 44, a result integration unit 45, a result presentation unit 46, a template storage unit 47, and an image insertion unit 48. The transmission/reception unit 41 transmits and receives information to and from another device such as the database device 2. The transmission/reception unit 41 is an acquisition unit that acquires the image data that is the data of the image captured by the camera 11 installed on the inspection robot 1. The image data of an inspection target is received from the database device 2 and is output to the classification unit 43 and the object detection unit 44. The image data of the inspection target is image data obtained by capturing the image of the generator as the inspection target on the day of inspection. The image data of the inspection target is, for example, stored in the data storage unit 23 of the database device 2 and also transmitted to the inspection support device 4.

Moreover, when receiving the classification model and the object detection model from the database device 2, the transmission/reception unit 41 stores the classification model and the object detection model in the model storage unit 42. The model storage unit 42 stores the classification model and the object detection model. As described above, the classification model and the object detection model may be received when the model is updated, or may be updated when an instruction to receive the model is given to the inspection support device 4 via input means (not illustrated), or when an instruction to receive the model is received from the display device 5.

The classification unit 43 uses the classification model and the image data acquired by the transmission/reception unit 41, which is the acquisition unit, to determine the class corresponding to the image data acquired by the transmission/reception unit 41, Specifically, the classification unit 43 inputs, to the classification model stored in the model storage unit 42, the image data of the inspection target received from the database device 2 via the transmission/reception unit 41, thereby performing classification of the image data and outputting a result of classification as a result of determination to the result integration unit 45. The classification is processing that uses the image represented by the image data to determine the class indicating the degree of anomaly in the generator as the inspection target. The class may include, for example, three classes corresponding to a high degree of anomaly, a low degree of anomaly, and no anomaly, two classes corresponding to abnormal and normal, or four classes. In addition, the class may include not only the degree of anomaly but also the type of anomaly such as a flaw, discoloration, and contamination by a foreign substance. Moreover, the class may be a combination of the degree of anomaly and the type of anomaly. For example, the class may be represented by values of four items being the degree of anomaly, the presence or absence of a flaw, the presence or absence of discoloration, and the presence or absence of contamination by a foreign substance. For example, a class corresponding to certain image data is represented by a low degree of anomaly, presence of a flaw, absence of discoloration, and absence of contamination by a foreign substance, and a class corresponding to another image data is represented by a high degree of anomaly, presence of a flaw, presence of discoloration, and presence of contamination by a foreign substance. Note that the definition of the class is not limited thereto.

The object detection unit 44 uses the object detection model and the image data acquired by the transmission/reception unit 41 to determine which object is the foreign substance in the image corresponding to the image data acquired by the transmission/reception unit 41. The object detection unit 44 inputs, to the object detection model stored in the model storage unit 42, the image data of the inspection target received from the database device 2 via the transmission/reception unit 41, thereby performing object detection in the image represented by the image data. The object detection in the present embodiment is processing of identifying a foreign substance. That is, the object detection unit 44 determines whether or not a foreign substance is present in the image, and when a foreign substance is present, outputs the name of an object that is the foreign substance to the result integration unit 45 as a result of determination. The object to be the foreign substance is defined in advance, and when the object detection model is generated, an image in which the foreign substance is present and the name of the object corresponding to the foreign substance are learned in association with each other. When a foreign substance is absent in the image, the object detection unit 44 outputs a result of determination indicating that a foreign substance is absent, that is, a result of determination indicating that the inspection target is normal, to the result integration unit 45.

In addition, the classification unit 43 and the object detection unit 44 each transmit the result of determination, together with identification information for identifying the corresponding image data, to the database device 2 via the transmission/reception unit 41. In the database device 2, when the transmission/reception unit 24 receives the result of determination, the result of determination is stored in the data storage unit 23 in association with the image data stored in the data storage unit 23.

The result integration unit 45 integrates the result of determination by the classification unit 43 and the result of determination by the object detection unit 44. For example, the result integration unit 45 may perform the integration by placing the results of determination corresponding to the same image together as one result of determination. Alternatively, when the result of determination by the classification unit 43 and the result of determination by the object detection unit 44 both indicate normal, the result integration unit 45 may set the results of determination as one result of determination being normal instead of placing the two results side by side. Moreover, when results of determination corresponding to a plurality of pieces of the image data consecutively have values indicating the same anomaly due to the same cause of anomaly, the result integration unit 45 may handle the plurality of pieces of the image data as one set, and associate the results of determination with the one set of the image data.

Moreover, the result integration unit 45 uses the result of determination by the classification unit 43 and the result of determination by the object detection unit 44 to select, from the image data acquired by the transmission/reception unit 41, image data to be checked that is the image data to be presented to an inspection worker. Specifically, on the basis of the result of determination by the classification unit 43, the result of determination by the object detection unit 44, and setting information set by the inspection worker, the result integration unit 45 determines whether or not to select the image data as the image data to be checked for each piece of the image data. The image data to be checked is a candidate of the image data to be presented to the inspection worker so as to be checked by the inspection worker. The setting information is input to the inspection support device 4 by the inspection worker via the display device 5 or via input means (not illustrated), and is stored in the template storage unit 47, As for the one set of the image data estimated to be associated with the same cause described above, a part of the image data in the one set of the image data may be selected as the image data to be checked, and whether to select all of the one set of the image data as the image data to be checked or a part of the image data as the image data to be checked is also designated by the setting information.

The setting information is information defining which result of determination makes the inspection worker desire to check the image data. The setting information may be a table in which whether or not to select the image data as the image data to be checked is set for each value of the result of determination by classification and the result of determination by the object detection unit 44, or may be one that sets a condition of a classification result to select the image data as the image data to be checked. For example, the setting information is set such that, when the classification is the high degree of anomaly or low degree of anomaly, the image data is selected as the image data to be checked regardless of the result of determination by the object detection unit 44, and when an object designated by the object detection unit 44 is detected as a foreign substance, the image data is selected as the image data to be checked regardless of the result of classification. The setting information is not limited thereto, and may be set as appropriate depending on what the inspection worker desires to check. Moreover, the getting information may be set such that a part of the image data that is normal is selected as the image data to be checked. In this case, for example, the setting information may specify that for how many images one normal image is selected as the image data to be checked, or that a normal image is selected as the image data to be checked at regular time intervals according to the date and time of imaging.

The result integration unit 45 outputs the image data determined as the image data to be checked to the result presentation unit 46 together with the integrated result of determination. The result presentation unit 46 transmits the image data and the corresponding result of determination received from the result integration unit 45 to the display device 5, thereby presenting the image data and the result of determination to the inspection worker. Note that, without being integrated, the results of determination may each be transmitted to the display device 5 together with the image data. Moreover, the result presentation unit 46 may have a function as a display unit and display the image represented by the image data and the corresponding result of determination received from the result integration unit 45, thereby presenting the image data and the result of determination. That is, the result presentation unit 46 may display an image based on the image data to be checked, or may transmit the image data to be checked to the display device 5 that displays the image based on the image data to be checked. The result integration unit 45 also stores the integrated result of determination and the image data in the template storage unit 47.

The template storage unit 47 stores a template of an inspection result report, the image data and the corresponding result of determination, the setting information, and inserted image selection information defining a condition of an image to be inserted into the inspection result report. The inserted image selection information is, for example, information defining how many images of which result of determination are to be inserted into the inspection result report, how many pieces of normal data are to be inserted into the inspection result report, and the like.

The image insertion unit 48 uses the result of determination by the classification unit 43 and the result of determination by the object detection unit 44 to select, from the image data acquired by the transmission/reception unit 41, the image data to be inserted into the inspection result report, and inserts the selected image into the template of the inspection result report. Specifically, the image insertion unit 48 uses the inserted image selection information stored in the template storage unit 47 to select, from among the image data stored in the template storage unit 47, the image data to be inserted into the inspection result report. The image insertion unit 48 reads the template of the inspection result report from the template storage unit 47, and inserts the selected image into the read template. The image insertion unit 48 outputs the template into which the image has been inserted to the result presentation unit 46. The result presentation unit 46 transmits the template received from the image insertion unit 48 to the display device 5. Note that the result of determination by machine learning typically includes information indicating accuracy of the result. For example, the image insertion unit 48 uses this accuracy to select an image with high accuracy and insert the image into the template.

The display device 5 includes a transmission/reception unit 51 and a display unit 52. The transmission/reception unit 51 transmits and receives information to and from another device such as the inspection support device 4. When receiving the image data and the corresponding result of determination from the inspection support device 4, the transmission/reception unit 51 outputs the image data and the corresponding result of determination to the display unit 52. The display unit 52 displays the image, which is represented by the image data received from the transmission/reception unit 51, together with the result of determination. An inspection worker visually inspects the generator as the inspection target by checking the image and the result of determination. As a result, the inspection worker can have a lighter load than when visually checking the video data acquired by the camera 11 at all times. Moreover, when receiving, from the inspection support device 4, the template of the inspection result report into which the image has been inserted, the transmission/reception unit 51 outputs the template to the display unit 52. The display unit 52 displays the template received from the transmission/reception unit 51. The inspection worker adds text to the displayed template using input means (not illustrated), and corrects the arrangement of the image and the like as necessary. As a result, the workload of creating the inspection result report can be reduced. Moreover, as a result of checking the image and the result of determination displayed, when the inspection worker wants to check additional image data such as image data acquired before and/or after the image data corresponding to the image, the inspection worker may input information specifying the image data requested for acquisition by input means (not illustrated). When receiving the image acquisition request, the display device 5 transmits a request for acquiring the image data to the database device 2 using the transmission/reception unit 51. When acquiring the corresponding image data from the database device 2, the transmission/reception unit 51 outputs the image data to the display unit 52, and the display unit 52 displays the image.

Note that, in the example illustrated in FIG. 1, the database device 2, the learning device 3, and the inspection support device 4 are separate devices, but two or more of the database device 2, the learning device 3, and the inspection support device 4 may be integrated into one device. Also, as described above, the display device 5 and the inspection support device 4 may be integrated.

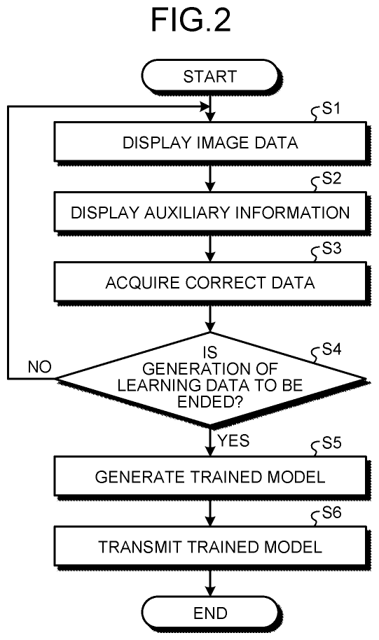

Next, the operation of the present embodiment will be described. First, the generation of the trained model in the learning device 3 of the present embodiment will be described. The present embodiment generates the two types of the trained models which are the classification model and the object detection model as described above. FIG. 2 is a flowchart illustrating an example of processing that generates the trained model of the present embodiment. FIG. 2 will be used to describe the processing in generating the classification model. As illustrated in FIG. 2, the learning device 3 displays image data (step S1), Specifically, the display unit 34 displays the image data received from the database device 2 via the transmission/reception unit 31 as an image. The image data acquired from the database device 2 to be used for generation of the trained model may be selected by an expert, or a period of acquisition of the image to be used for generation of the trained model may be set in advance, and the image data corresponding to the period may be transmitted from the database device 2 to the learning device 3. In the case where the image data is selected by the expert, for example, the transmission/reception unit 31 may acquire, from the database device 2, information indicating a list of the image data stored in the database device 2, and the information may be displayed on the display unit 34 for selection and designation by the expert. The information indicating the image designated by the expert is received by input means (not illustrated) and transmitted to the database device 2 by the transmission/reception unit 31,

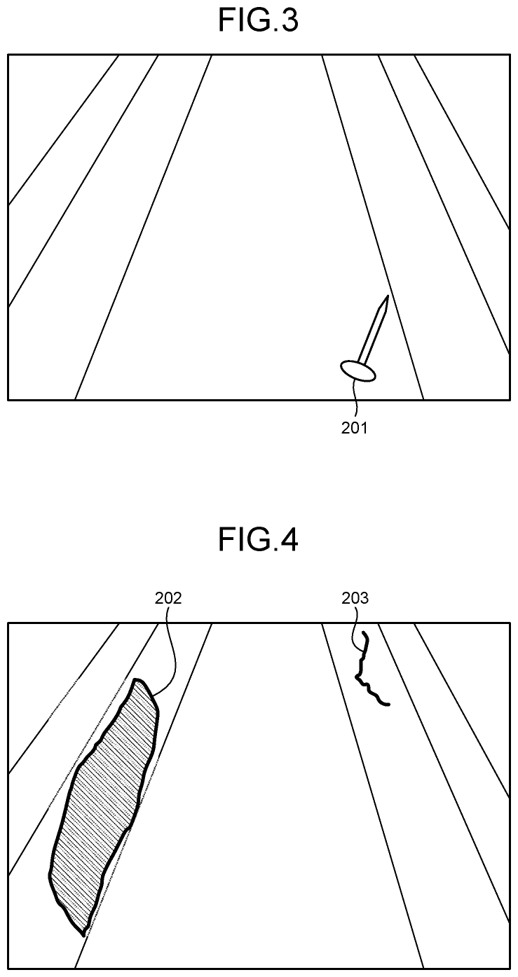

FIG. 3 is a diagram schematically illustrating an example of the image displayed by the display unit 34 of the present embodiment. In the example illustrated in FIG. 3, a nail 201 as an example of a foreign substance is present in the image. FIG. 4 is a diagram schematically illustrating another example of the image displayed by the display unit 34 of the present embodiment. In the example illustrated in FIG. 4, a discolored region 202 and a flaw 203 are present in the image. The expert visually recognizes the image as illustrated in FIGS. 3 and 4 and determines the class corresponding to the state inside the generator represented by the image.

In addition, the learning device 3 displays auxiliary information (step S2). Specifically, the display unit 34 displays the auxiliary information received from the database device 2 via the transmission/reception unit 31. The auxiliary information is auxiliary information corresponding to the image data displayed in step S1, and is displayed together with the image represented by the image data, for example. The auxiliary information is information used as reference information when the expert determines the class of the degree of anomaly corresponding to the image data. As described above, the auxiliary information includes the information such as the operation start date of the generator, the design information indicating the color, the shape, and the like of the generator, the past inspection date, and the past inspection result and is, for example, at least one of these pieces of information, but may include information other than these pieces of information.

The expert refers to the auxiliary information when determining the class corresponding to the image, thereby being able to determine the class more appropriately than when the auxiliary information is not displayed. For example, if the expert who determines the class from the image is very knowledgeable about the generator, he/she can make an appropriate determination promptly, but for some experts, it may be difficult to determine the class by the image alone. In such a case, the expert refers to the auxiliary information to be able to determine the class appropriately and promptly. Moreover, the expert does not need to separately search for and check the design information of the generator, the operation start date, the previous inspection result, and the like, so that the workload of the expert can be reduced.

Next, the learning device 3 acquires correct data (step S3). Specifically, the correct data reception unit 35 outputs a result of determination of the class input from the expert to the classification model generation unit 32 as the correct data. As described above, this class is classified by the degree of anomaly, for example, but may include the type of anomaly.

Next, the learning device 3 determines whether or not to end the generation of learning data (step S4), and in a case where the generation of the learning data is not to be ended (No in step 4), the processing from step S1 is repeated. Specifically, in step S4, in a case where the classification model generation unit 32 has successfully acquired a predetermined number of pieces of the learning data, for example, the learning device 3 determines to end the generation of the learning data.

In a case of ending the generation of the learning data (Yes in step S4), the learning device 3 generates a trained model (step S5), Specifically, the classification model generation unit 32 uses a plurality of learning data sets, each of which includes the image data and the correct data as a set, to perform supervised learning and generate the trained model for classifying the image data, that is, for inferring a corresponding class from the image data, and outputs the trained model to the transmission/reception unit 31.

Any algorithm may be used as the supervised learning algorithm, and, for example, a neural network model can also be used. A neural network includes an input layer including a plurality of neurons, a middle layer (hidden layer) including a plurality of neurons, and an output layer including a plurality of neurons. The middle layer may be one layer or two or more layers.

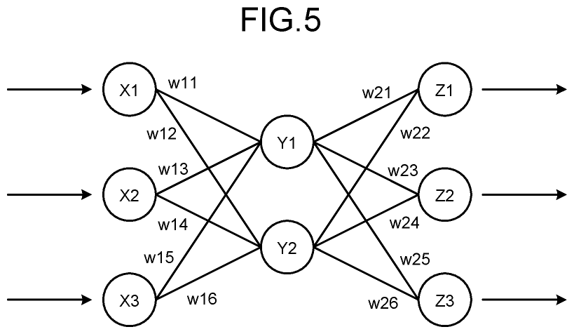

FIG. 5 is a schematic diagram illustrating an example of the neural network. For example, in the case of a three-layer neural network as illustrated in FIG. 5, when a plurality of inputs are input to input layers (X1 to X3), the values are multiplied by weights W1 (w11 to w16) and input to middle layers (Y1 and Y2), and the results are further multiplied by weights W2 (w21 to w26) and output from output layers (Z1 to Z3). This output result varies depending on the values of the weights W1 and W2.

In the present embodiment, a relationship between a feature value, which is the image data, and the correct data is learned by adjusting the weights W1 and W2 such that when the feature value is input, the output from the output layer is close to the correct data. Note that the machine learning algorithm is not limited to the neural network.

The description refers back to FIG. 2. Next, the learning device 3 transmits the trained model generated (step S6), and ends the processing of generating the trained model. Specifically, the transmission/reception unit 31 transmits the classification model, which is the trained model received from the classification model generation unit 32, to the database device 2.

The object detection model is similarly generated by the processing procedure illustrated in FIG. 2. At the time of generating the object detection model, in step S3 described above, the name of an object that is a foreign substance is input as the correct data. For example, in the example illustrated in FIG. 3, “nail” is input as the correct data. Also, in the example illustrated in FIG. 4, information indicating that a foreign substance is absent is input as the correct data. Moreover, in a case where the database device 2 stores an image of an object detected as a foreign substance in the generator previously captured by an imaging device other than the inspection robot 1, the learning device 3 may acquire and display image data of the image and receive an input of correct data corresponding to the image data. Examples of the object learned as the foreign substance include a nail, a piece of plastic, a piece of epoxy, and the like, but are not limited thereto, and may include an object previously detected as a foreign substance in the generator, an object possibly present as a foreign substance, and the like.

At the time of generating the object detection model, in step S5 described above, the object detection model generation unit 33 uses a plurality of learning data sets, each of which includes the image data and the correct data as a set, to perform supervised learning and generate the trained model for determining the object from the image data. When the operation performed by the classification model generation unit 32 in generating the classification model is thus performed by the object detection model generation unit 33, the object detection model that is the trained model is generated by the processing illustrated in FIG. 2 as with the classification model, and is transmitted to the database device 2.

Next, inspection support processing in the inspection support device 4 of the present embodiment will be described. The inspection support device 4 acquires the classification model and the object detection model described above via the database device 2, and stores the classification model and the object detection model in the model storage unit 42.

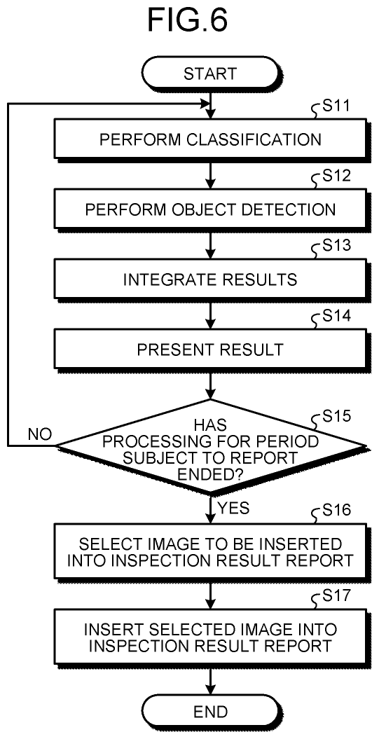

FIG. 6 is a flowchart illustrating an example of the inspection support processing in the inspection support device 4 of the present embodiment. As illustrated in FIG. 6, the inspection support device 4 performs classification (step S11), Specifically, the transmission/reception unit 41 acquires the image data of the inspection target from the database device 2, and outputs the image data to the classification unit 43 and the object detection unit 44. The classification unit 43 reads the classification model from the model storage unit 42, inputs the image data received from the transmission/reception unit 41 to the classification model read, and obtains an output value, thereby obtaining a result of classification, that is, a result of determination of the class.

The inspection support device 4 performs object detection (step S12). The object detection unit 44 reads the object detection model from the model storage unit 42, inputs the image data received from the transmission/reception unit 41 to the object detection model read, and obtains an output value, thereby obtaining an identification result of a foreign substance, that is, a result of determination of object detection, and outputting the result of determination to the result integration unit 45. Note that step S11 and step S12 described above may be performed concurrently.

The inspection support device 4 integrates the results (step S13). Specifically, the result integration unit 45 integrates the result of determination received from the object detection unit 44 and the result of determination received from the classification unit 43. As described above, the integration of the results includes the processing of putting the results of determination corresponding to the same image data into one result of determination, and the processing of determining whether or not to select the image data as the image data to be checked on the basis of the setting information. The result integration unit 45 outputs the image data determined to be checked to the result presentation unit 46 together with the integrated result of determination. The result integration unit 45 also stores the result of determination and the image data in the template storage unit 47.

The inspection support device 4 presents the result (step S14). Specifically, the result presentation unit 46 transmits the image data and the corresponding result of determination to the display device 5. When receiving the image data and the corresponding result of determination, the display device 5 displays the image represented by the image data and the result of determination.

The inspection support device 4 determines whether or not the processing for a period subject to report has ended (step 15). Specifically, the result integration unit 45 determines whether or not the processing of steps S11 to S14 has been performed with respect to the image data for a period subject to preparation of an inspection result report. As for the period subject to preparation of the inspection result report, for example, date and time may be designated in advance, the display device 5 may send a notification of the end of the processing for the period subject to report, or an instruction to end the processing for the period subject to report may be input by input means (not illustrated) of the inspection support device 4.

In a case where the processing for the period subject to report has not ended (No in step S15), the inspection support device 4 repeats the processing from step S11. In a case where the processing for the period subject to report has ended (Yes in step S15), the inspection support device 4 selects an image to be inserted into the inspection result report (step S16), and inserts the selected image into the inspection result report (step S17). Specifically, the image insertion unit 48 uses the inserted image selection information stored in the template storage unit 47 to select, from among the image data stored in the template storage unit 47, the image data to be inserted into the inspection result report. Then, the image insertion unit 48 inserts the selected image into the inspection result report by inserting the selected image into the template of the inspection result report stored in the template storage unit 47, and transmits the template to the display device 5 via the result presentation unit 46.

The inspection support device 4 performs the above processing to allow an inspection worker to visually inspect the generator as the inspection target by checking the image and the result of determination displayed on the display device 5. As a result, the inspection worker can have a lighter load than when visually checking the video data acquired by the camera 11 at all times. Also, when the setting information is set such that the image data is to be checked in a case where the image data is determined to be not normal by at least one of the two types of the results of determination, the inspection worker can check the image data even if either one of the results of determination is wrong, whereby the accuracy of detecting an anomaly in the inspection can be increased.

Next, relearning using the result of determination will be described. The inspection support device 4 transmits the result of determination by classification and the result of determination by object detection to the database device 2. The learning device 3 acquires these two types of results of determination from the database device 2 and performs relearning in a case where the two types of results of determination do not match, thereby being able to increase the accuracy of the trained model.

In general, the object detection model needs to identify a foreign substance, and thus it is considered difficult to construct the trained model with high accuracy compared to the classification model. Accordingly, for example, in a case where the image data determined to have a high degree of anomaly by classification and determined to have no foreign substance by object detection is checked and found to actually have a foreign substance, the image data is relearned in association with the name of an object as the foreign substance confirmed, whereby the accuracy of object detection can be increased. Conversely, in a case where the image data is determined to have a foreign substance and determined to have no anomaly by classification, a foreign substance may actually be absent when the image data is checked. In such a case as well, the image data is relearned in association with the correct data that a foreign substance is absent, whereby the accuracy of object detection can be increased.

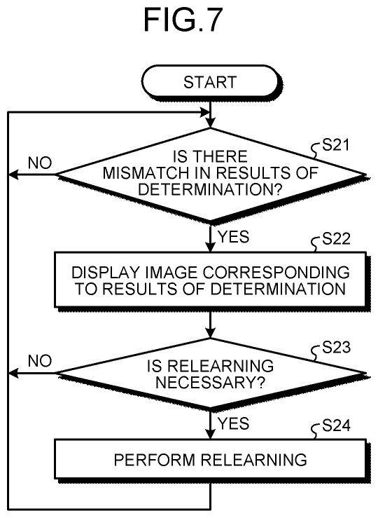

FIG. 7 is a flowchart illustrating an example of relearning processing of the present embodiment. The processing illustrated in FIG. 7 may be performed, for example, periodically or when an instruction is given from an expert. The image data and the results of determination subject to processing are, for example, designated by an expert using input means not illustrated. As illustrated in FIG. 7, the learning device 3 determines whether or not there is a mismatch in the results of determination (step S21). Specifically, the relearning determination unit 36 uses the image data and the corresponding two types of results of determination received via the transmission/reception unit 31 to determine whether there is a mismatch in the results of determination in cases, for example, where object detection detects a foreign substance but classification determines that there is no anomaly, and where object detection detects no foreign substance but classification determines that there is an anomaly.

In a case where there is no mismatch in the results of determination (No in step S21), the learning device 3 changes the processing target to the next image data and results of determination and repeats the processing from step S21. In a case where there is a mismatch in the results of determination (Yes in step S21), the learning device 3 displays an image corresponding to the results of determination (step S22). Specifically, in step S22, the relearning determination unit 36 outputs the image data corresponding to the results of determination, which are determined to have the mismatch, to the display unit 34 as a relearning candidate and causes the display unit 34 to display the image data, so that the display unit 34 displays an image represented by the image data. As a result, an expert checks the image and determines whether or not the result of determination by object detection corresponding to the image data is wrong.

The learning device 3 determines whether or not relearning is necessary (step S23). Specifically, the correct data reception unit 35 receives an input of an instruction as to whether or not relearning is necessary from an expert, and outputs the received instruction to the relearning determination unit 36, so that the relearning determination unit 36 determines whether or not relearning is necessary on the basis of the received instruction. That is, when the display unit 34 displays the image based on the relearning candidate, the correct data reception unit 35 receives an input indicating whether or not relearning is necessary, and receives an input indicating that relearning is necessary.

In a case where relearning is not necessary (No in step S23), the learning device 3 changes the processing target to the next image data and results of determination and repeats the processing from step S21. In a case where relearning is necessary (Yes in step S23), the learning device 3 performs relearning (step S24), changes the processing target to the next image data and results of determination, and repeats the processing from step S21. In step S24, specifically, the relearning determination unit 36 instructs the object detection model generation unit 33 to perform relearning, and the correct data reception unit 35 receives an input of the correct data from an expert and outputs the received correct data to the object detection model generation unit 33. The object detection model generation unit 33 uses a learning data set, which includes the image data displayed in step S22 and the correct data as a set, to perform relearning and update the object detection model. That is, the object detection model generation unit 33 uses the relearning candidate and the name of the object received by the correct data reception unit 35 as the learning data set to perform relearning. Note that relearning may be performed after a certain number of pieces of learning data are accumulated.

The updated object detection model is transmitted to the database device 2, and transmitted from the database device 2 to the inspection support device 4. As a result, the object detection model stored in the inspection support device 4 is updated. In the example described above, the example of updating the object detection model has been described, but the classification model may be similarly updated.

Moreover, in the example described above, the learning device 3 determines whether or not to perform relearning using the result determined by the inspection support device 4, but the relearning determination unit 36 may obtain two types of results of determination by imputing the image data acquired from the database device 2 to each of the classification model and the object detection model, and the processing illustrated in FIG. 7 may be performed.

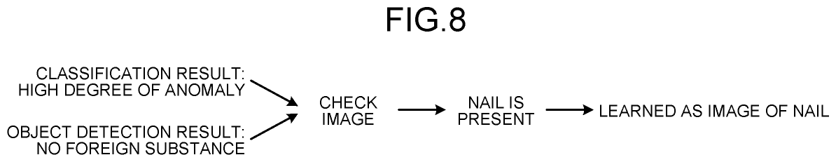

FIG. 8 is a diagram illustrating an example of relearning of the present embodiment. As illustrated in FIG. 8, for example, it is assumed that a high degree of anomaly is determined by classification, and no foreign substance is detected by object detection. In this case, an image is displayed by step S22 described above. Then, when an expert confirms that the mail 201 is present in the image as in the image illustrated in FIG. 3, the image is relearned as an image of the mail. That is, the name of the object “nail” is given as the correct data, and relearning is performed using the learning data including the image data and the correct data as a set, whereby the object detection model is updated.

As described above, since the inspection support system of the present embodiment uses the two types of the trained models, in a case where the results of determination using the two types of the trained models have a mismatch, the image is checked and can be relearned when relearning is necessary. As a result, the accuracy of detecting an anomaly can be increased.

Moreover, in a case where the database device 2 stores data related to a plurality of the generators, a trained model is generated for each of the generators. Also, in a case where an expert determines that some of the generators have similar specifications or the like on the basis of the auxiliary information of the generators, by an instruction from the expert, the learning device 3 may use the data of these generators together as the learning data to generate the trained model. For example, it is possible to integrate generators or the like that are manufactured by the same manufacturer, have stators and rotors painted in similar colors, and have relatively close operating periods.

Moreover, although the example described above uses the two types of the trained models, three or more types of trained models may be used. For example, in addition to the classification model and the object detection model described above, the learning device 3 may generate a range extraction model for extracting the range of an object as a trained model, and the inspection support device 4 may extract the shape of a foreign substance using the range extraction model.

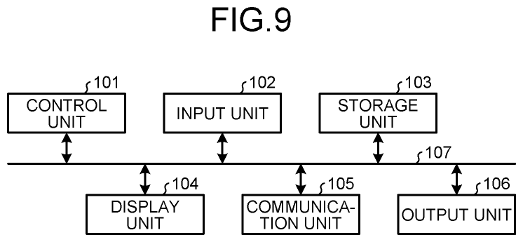

Next, hardware configurations of the database device 2, the learning device 3, and the inspection support device 4 of the present embodiment will be described. Aa for the database device 2, the learning device 3, and the inspection support device 4 of the present embodiment, a computer system executes a computer program describing the processing in each of the database device 2, the learning device 3, and the inspection support device 4, thereby functioning as each of the database device 2, the learning device 3, and the inspection support device 4. FIG. 9 is a diagram illustrating an example of a configuration of the computer system that implements the inspection support device 4 of the present embodiment. As illustrated in FIG. 9, the computer system includes a control unit 101, an input unit 102, a storage unit 103, a display unit 104, a communication unit 105, and an output unit 106, which are connected via a system bus 107. Similarly, the database device 2 and the learning device 3 are each implemented by the computer system illustrated in FIG. 9, for example.

In FIG. 9, the control unit 101 is, for example, a processor such as a central processing unit (CPU), and executes the inspection support program describing the processing in the inspection support device 4 of the present embodiment. The input unit 102 includes, for example, a keyboard, a mouse, and the like and is used by a user of the computer system to input various information. The storage unit 103 includes various memories such as a random access memory (RAM) and a read only memory (ROM) as well as a storage device such as a hard disk, and stores a program to be executed by the control unit 101, necessary data obtained in the course of processing, and the like. The storage unit 103 is also used as a temporary storage area for the program. The display unit 104 includes a display, a liquid crystal display (LCD) panel, and the like and displays various screens to the user of the computer system. The communication unit 105 is a receiver and a transmitter that perform communication processing. The output unit 106 is a printer, a speaker, and the like. Note that FIG. 9 illustrates an example and does not limit the configuration of the computer system.

Here, a description will be given of an example of the operation of the computer system for making the inspection support program of the present embodiment executable. In the computer system having the above configuration, the inspection support program is installed to the storage unit 103 from, for example, a compact disc (CD)-ROM or a digital versatile disc (DVD)-ROM set in a CD-ROM drive or a DVD-ROM drive not illustrated. When executed, the inspection support program read from the storage unit 103 is stored in a main storage area of the storage unit 103. In this state, the control unit 101 executes the processing as the inspection support device 4 of the present embodiment according to the program stored in the storage unit 103.

Note that the above description provides the program describing the processing in the inspection support device 4 by using the CD-ROM or DVD-ROM as a recording medium, but the program is not limited thereto, depending on the configuration of the computer system, the capacity of the program provided, and the like, for example, the program may be provided for use through a transmission medium such as the Internet via the communication unit 105.

The classification unit 43, the object detection unit 44, the result integration unit 45, and the image insertion unit 48 illustrated in FIG. 1 are implemented when the inspection support program stored in the storage unit 103 illustrated in FIG. 9 is executed by the control unit 101 illustrated in FIG. 9. The model storage unit 42 and the template storage unit 47 illustrated in FIG. 1 are a part of the storage unit 103 illustrated in FIG. 9. The transmission/reception unit 41 and the result presentation unit 46 illustrated in FIG. 1 are implemented by the communication unit 105 illustrated in FIG. 9. The inspection support device 4 may be implemented by a plurality of the computer systems. For example, the inspection support device 4 may be implemented by a cloud computer system.

For example, the inspection support program of the present embodiment causes the computer system to executes a step of acquiring image data that is data of an image captured by the camera installed on the inspection robot capable of traveling inside the generator; and a step of performing first determination processing of determining the class corresponding to the image data acquired, by using a classification model, which is a trained model for determining a class indicating a degree of anomaly of the generator from the image data, and the image data acquired. The inspection support program further causes the computer system to executes a step of performing second determination processing of determining which object is the foreign substance in an image corresponding to the image data acquired, by using an object detection model, which is a trained model for identifying a foreign substance in the generator from the image data, and the image data acquired; a step of using a result of determination by the first determination processing and a result of determination by the second determination processing and selecting, from the image data acquired, image data to be checked that is the image data to be presented to an inspection worker; and a step of presenting the image data to be checked, the result of determination by the first determination processing, and the result of determination by the second determination processing to the inspection worker.

Moreover, the still image generation unit 22 of the database device 2 illustrated in FIG. 1 is implemented when the program stored in the storage unit 103 illustrated in FIG. 9 is executed by the control unit 101 illustrated in FIG. 9. The data storage unit 23 and the model storage unit 25 illustrated in FIG. 1 are a part of the storage unit 103 illustrated in FIG. 9. The data acquisition unit 21 and the transmission/reception unit 24 illustrated in FIG. 1 are implemented by the communication unit 105 illustrated in FIG. 9. The database device 2 may be implemented by a plurality of the computer systems. For example, the database device 2 may be implemented by a cloud computer system.

Moreover, the classification model generation unit 32, the object detection model generation unit 33, and the relearning determination unit 36 of the learning device 3 illustrated in FIG. 1 are implemented when the program stored in the storage unit 103 illustrated in FIG. 9 is executed by the control unit 101 illustrated in FIG. 9. The transmission/reception unit 31 illustrated in FIG. 1 is implemented by the communication unit 105 illustrated in FIG. 9. The display unit 34 illustrated in FIG. 1 is implemented by the display unit 104 illustrated in FIG. 9. The correct data reception unit 35 illustrated in FIG. 1 is implemented by the input unit 102 illustrated in FIG. 9. The learning device 3 may be implemented by a plurality of the computer systems. For example, the learning device 3 may be implemented by a cloud computer system.

As described above, the inspection support device 4 of the present embodiment determines the presence or absence of anomaly of the generator by using the two types of the trained models and the image data, selects the image data to be checked from the acquired image data on the basis of the two types of the results of determination, and transmits the image data to the display device 5. This allows an inspection worker to visually inspect the generator as the inspection target by checking the image and the results of determination displayed on the display device 5. As a result, the inspection worker can have a lighter load than when visually checking the video data acquired by the camera 11 at all times.

Moreover, the learning device 3 of the present embodiment displays the auxiliary information, which is the information related to the generator, together with the image when receiving the input of the correct data for generating the trained model. This can reduce the load on an expert who inputs the correct data. In addition, the learning device 3 of the present embodiment uses the two types of the results of determination obtained by the inspection support device 4 to display the corresponding image in a case where the two types of the results of determination do not match, and perform relearning in a case where relearning is necessary. Aa a result, the accuracy of the trained model can be improved.

The configuration illustrated in the above embodiment merely illustrates an example, and thus another known technique can be combined, embodiments can be combined together, or the configuration can be partially omitted and/or modified without departing from the scope of the present disclosure.

### REFERENCE SIGNS LIST

1 inspection robot, 2 database device; 3 learning device; 4 inspection support device; 5 display device; 11 camera; 12 communication unit; 21 data acquisition unit; 22 still image generation unit; 23 data storage unit; 24, 31, 41, 51 transmission/reception unit; 25, 42 model storage unit; 32 classification model generation unit; 33 object detection model generation unit; 34, 52 display unit; 35 correct data reception unit; 36 relearning determination unit; 43 classification unit; 44 object detection unit; 45 result integration unit; 46 result presentation unit; 47 template storage unit; 48 image insertion unit.

1. An inspection support device comprising:
a processor to execute a program; and
a memory to store the program which, when executed by the processor, performs
an acquisition process to acquire image data that is data of an image captured by a camera installed on an inspection robot capable of traveling inside a generator;
a classification process to use a classification model, which is a trained model for determining a class indicating a degree of anomaly of the generator from the image data, and the image data acquired by the acquisition process to determine the class corresponding to the image data acquired by the acquisition-process;
an object detection process to use an object detection model, which is a trained model for identifying a foreign substance in the generator from image data, and the image data acquired by the acquisition process to determine which object is the foreign substance in an image corresponding to the image data acquired by the acquisition-process;
a result integration process to use a result of determination by the classification process and a result of determination by the object detection process to select, from the image data acquired by the acquisition process, image data to be checked that is the image data to be presented to an inspection worker; and
a result presentation process to present the image data to be checked, the result of determination by the classification process, and the result of determination by the object detection process to the inspection worker.

2. The inspection support device according to claim 1, wherein the program, when executed by the processor, performs
an image insertion process to use the result of determination by the classification process and the result of determination by the object detection process to select, from the image data acquired by the acquisition process, the image data to be inserted into an inspection result report, and insert the image selected into a template of the inspection result report.

3. The inspection support device according to claim 1 or 2, wherein the result presentation process includes displaying an image based on the image data to be checked.

4. The inspection support device according to claim 1 or 2, wherein the result presentation process includes transmitting the image data to be checked to a display device that displays an image based on the image data to be checked.

5. An inspection support system comprising:
a processor to execute a program; and
a memory to store the program which, when executed by the processor, implements:
a learning device to generate a classification model and an object detection model, the classification model being a trained model for determining a class indicating a degree of anomaly of a generator from image data, and the object detection model being a trained model for identifying a foreign substance in the generator from image data; and
an inspection support device to support an inspection of the generator, wherein
the program, when executed by the processor, performs processes of the inspection support device, the processes including:
an acquisition process to acquire the image data that is data of an image captured by a camera installed on an inspection robot capable of traveling inside the generator;
a classification process to use the classification model and the image data acquired by the acquisition process to determine the class corresponding to the image data acquired by the acquisition process;
an object detection process to use the object detection model and the image data acquired by the acquisition process to determine which object is the foreign substance in an image corresponding to the image data acquired by the acquisition process;
a result integration process to use a result of determination by the classification process and a result of determination by the object detection process to select, from the image data acquired by the acquisition process, image data to be checked that is the image data to be presented to an inspection worker; and
a result presentation process to present the image data to be checked, the result of determination by the classification process, and the result of determination by the object detection process to the inspection worker.

6. The inspection support system according to claim 5, comprising the inspection robot.

7. The inspection support system according to claim 5 or 6, comprising
a display device to display an image based on the image data to be checked, wherein
the result presentation process includes transmitting the image data to be checked to the display device.

8. The inspection support system according to claim 5, wherein
the program, when executed by the processor, performs processes of the learning device, the processes including:
a display process to display an image based on the image data captured by the camera;
a correct data reception process to receive an input of the result of determination of the class that is correct data for generating the classification model corresponding to the image data, and receive an input of a name of the object as the foreign substance that is correct data for generating the object detection model corresponding to the image data;
a classification model generation process to generate the classification model by using a plurality of learning data sets each including the image data and the result of determination of the class received by the correct data reception process; and
an object detection model generation process to generate the object detection model by using a plurality of learning data sets each including the image data and the name of the object received by the correct data reception process.

9. The inspection support system according to claim 8, wherein the display process includes displaying auxiliary information together with the image, the auxiliary information including at least one of an operation start date of the generator, design information of the generator, or a past inspection result of the generator.

10. The inspection support system according to claim 8, wherein
the processes of the learning device include
a relearning determination process to determine the image data as a relearning candidate in a case where a result of determination obtained by inputting the image data to the classification model does not match a result of determination obtained by inputting the image data to the object detection model, and cause the display process to display an image based on the relearning candidate,
the correct data reception process includes receiving an input indicating whether or not relearning is necessary when the image based on the relearning candidate is displayed in the display process, and receiving an input of the name of the object that is the correct data corresponding to the object detection model when receiving an input indicating that relearning is necessary, and
the object detection model generation process includes updating the object detection model by performing relearning using the relearning candidate and the name of the object received by the correct data reception process as a learning data set.

11. An inspection support method by an inspection support device that supports an inspection of a generator, the inspection support method comprising:
acquiring image data that is data of an image captured by a camera installed on an inspection robot capable of traveling inside the generator;
performing first determination processing of determining the class corresponding to the image data acquired, by using a classification model, which is a trained model for determining a class indicating a degree of anomaly of the generator from the image data, and the image data acquired;
performing second determination processing of determining which object is the foreign substance in an image corresponding to the image data acquired, by using an object detection model, which is a trained model for identifying a foreign substance in the generator from image data, and the image data acquired;
using a result of determination by the first determination processing and a result of determination by the second determination processing and selecting, from the image data acquired, image data to be checked that is the image data to be presented to an inspection worker; and
presenting the image data to be checked, the result of determination by the first determination processing, and the result of determination by the second determination processing to the inspection worker.

12. A non-transitory storage medium storing an inspection support program that causes a computer system to execute:
acquiring image data that is data of an image captured by a camera installed on an inspection robot capable of traveling inside a generator;
performing first determination processing of determining the class corresponding to the image data acquired, by using a classification model, which is a trained model for determining a class indicating a degree of anomaly of the generator from the image data, and the image data acquired;
performing second determination processing of determining which object is the foreign substance in an image corresponding to the image data acquired, by using an object detection model, which is a trained model for identifying a foreign substance in the generator from image data, and the image data acquired;
using a result of determination by the first determination processing and a result of determination by the second determination processing and selecting, from the image data acquired, image data to be checked that is the image data to be presented to an inspection worker; and
presenting the image data to be checked, the result of determination by the first determination processing, and the result of determination by the second determination processing to the inspection worker.

13. The inspection support system according to claim 6, wherein
the program, when executed by the processor, performs processes of the learning device, the processes including:
a display process to display an image based on the image data captured by the camera;
a correct data reception process to receive an input of the result of determination of the class that is correct data for generating the classification model corresponding to the image data, and receive an input of a name of the object as the foreign substance that is correct data for generating the object detection model corresponding to the image data;
a classification model generation process to generate the classification model by using a plurality of learning data sets each including the image data and the result of determination of the class received by the correct data reception process; and
an object detection model generation process to generate the object detection model by using a plurality of learning data sets each including the image data and the name of the object received by the correct data reception process.

14. The inspection support system according to claim 7, wherein
the program, when executed by the processor, performs processes of the learning device, the processes including:
a display process to display an image based on the image data captured by the camera;
a correct data reception process to receive an input of the result of determination of the class that is correct data for generating the classification model corresponding to the image data, and receive an input of a name of the object as the foreign substance that is correct data for generating the object detection model corresponding to the image data;
a classification model generation process to generate the classification model by using a plurality of learning data sets each including the image data and the result of determination of the class received by the correct data reception process; and
an object detection model generation process to generate the object detection model by using a plurality of learning data sets each including the image data and the name of the object received by the correct data reception process.

15. The inspection support system according to claim 13, wherein the display process includes displaying auxiliary information together with the image, the auxiliary information including at least one of an operation start date of the generator, design information of the generator, or a past inspection result of the generator.

16. The inspection support system according to claim 14, wherein the display process includes displaying auxiliary information together with the image, the auxiliary information including at least one of an operation start date of the generator, design information of the generator, or a past inspection result of the generator.

17. The inspection support system according to claim 13, wherein
the processes of the learning device include
a relearning determination process to determine the image data as a relearning candidate in a case where a result of determination obtained by inputting the image data to the classification model does not match a result of determination obtained by inputting the image data to the object detection model, and cause the display process to display an image based on the relearning candidate,
the correct data reception process includes receiving an input indicating whether or not relearning is necessary when the image based on the relearning candidate is displayed in the display process, and receiving an input of the name of the object that is the correct data corresponding to the object detection model when receiving an input indicating that relearning is necessary, and
the object detection model generation process includes updating the object detection model by performing relearning using the relearning candidate and the name of the object received by the correct data reception process as a learning data set.

18. The inspection support system according to claim 14, wherein
the processes of the learning device include
a relearning determination process to determine the image data as a relearning candidate in a case where a result of determination obtained by inputting the image data to the classification model does not match a result of determination obtained by inputting the image data to the object detection model, and cause the display process to display an image based on the relearning candidate,
the correct data reception process includes receiving an input indicating whether or not relearning is necessary when the image based on the relearning candidate is displayed in the display process, and receiving an input of the name of the object that is the correct data corresponding to the object detection model when receiving an input indicating that relearning is necessary, and
the object detection model generation process includes updating the object detection model by performing relearning using the relearning candidate and the name of the object received by the correct data reception process as a learning data set.

19. The inspection support system according to claim 9, wherein
the processes of the learning device include
a relearning determination process to determine the image data as a relearning candidate in a case where a result of determination obtained by inputting the image data to the classification model does not match a result of determination obtained by inputting the image data to the object detection model, and cause the display process to display an image based on the relearning candidate,
the correct data reception process includes receiving an input indicating whether or not relearning is necessary when the image based on the relearning candidate is displayed in the display process, and receiving an input of the name of the object that is the correct data corresponding to the object detection model when receiving an input indicating that relearning is necessary, and
the object detection model generation process includes updating the object detection model by performing relearning using the relearning candidate and the name of the object received by the correct data reception process as a learning data set.

20. The inspection support system according to claim 15, wherein
the processes of the learning device include
a relearning determination process to determine the image data as a relearning candidate in a case where a result of determination obtained by inputting the image data to the classification model does not match a result of determination obtained by inputting the image data to the object detection model, and cause the display process to display an image based on the relearning candidate,
the correct data reception process includes receiving an input indicating whether or not relearning is necessary when the image based on the relearning candidate is displayed in the display process, and receiving an input of the name of the object that is the correct data corresponding to the object detection model when receiving an input indicating that relearning is necessary, and
the object detection model generation process includes updating the object detection model by performing relearning using the relearning candidate and the name of the object received by the correct data reception process as a learning data set.

21. The inspection support system according to claim 16, wherein
the processes of the learning device include
a relearning determination process to determine the image data as a relearning candidate in a case where a result of determination obtained by inputting the image data to the classification model does not match a result of determination obtained by inputting the image data to the object detection model, and cause the display process to display an image based on the relearning candidate,
the correct data reception process includes receiving an input indicating whether or not relearning is necessary when the image based on the relearning candidate is displayed in the display process, and receiving an input of the name of the object that is the correct data corresponding to the object detection model when receiving an input indicating that relearning is necessary, and
the object detection model generation process includes updating the object detection model by performing relearning using the relearning candidate and the name of the object received by the correct data reception process as a learning data set.
